(19) United States
(12) Patent Application Publication
(10) Pub. No.: US 2003/0172209 A1
(43) Pub. Date: Sep. 11, 2003

(54) Video/audio media player supporting various flash memory cards

(76) Inventors: Wen-Tsung Liu, Taipei (TW); Chia-Li Chen, Taipei (TW)

Correspondence Address: Hsu & Associates, P. O. Box 72, Taipei, TW

(21) Appl. No.: 10/216,614

(22) Filed: Aug. 12, 2002

(30) Foreign Application Priority Data
Mar. 5, 2002 (TW) 091202516

(51) Int. Cl. G06F 13/12

(52) U.S. Cl. 710/62

(57) ABSTRACT

A video/audio media player supports various flash memory cards, and includes several flash memory card sockets, a digital signal processor, a microprocessor, a transfer interface, a video encoding unit, and an audio decoding unit to access various flash memory cards. It supports USB and 1394 interfaces, and can be independently used in HDTVs, PCs, or Hi-Fi Systems for video steam encoding/decoding, digital/analog data conversion, etc. It enhances the interoperability of flash memory cards and brings convenience to video/audio data transfer.

### BACKGROUND OF THE INVENTION

1. Field of the Invention

The present invention is related with a video/audio media player, in particular, to a video/audio media player supporting various flash memory cards. It not only can play MP3/MPEG/JPEG video, audio, or pictures, but also supports access to various flash memory cards and plug-and-play interface.

2. Description of Related Art

In today's multimedia time, digital video/audio products become people's favorites, such as DSC, Digital Media Player, Digital Frame, and Information Appliances (e.g., HDTV) Because digital video/audio player products can connect directly to computers, networks, even HDTVs without legacy encoding/decoding processes, no distortion exists in the transmission of videos/audios and graphics. Traditional diskettes or tape products have been substituted with digital video/audio products. The customers can download films and graphics from networks, or convert videos/audios into JPEG, MPEG, MP3, or CD-DA formats, and then store them in various flash memory cards for latter use.

The transmission of digital video/audio data across network brings us unlimited business opportunities. Therefore, many businesses try their best to take a better position in this market, and their activities stimulate the demand for digital video/audio products in the international market. As shown in FIG. 1, the architecture of a typical digital audio/video product comprises of a Digital Signal Processor (DSP) (2) to process the digital video/audio data in the CF Card (no shown in the figure) inserted in the CF Card Socket (6) and then transfer the processed digital signal to a Video Encoding Unit (3) and Audio Encoding Unit (7). The Video Encoding Unit (3) can be connected to the LCD screen (5) via the RGB terminal (4), while the Audio Encoding Unit (7) decodes the audio signal into a left track (8a) and a right track (8b), which can be sent to the Hi-Fi System. The DSP (2) accepts inputs (9) to control the play action of this digital product. Legacy digital video/audio products, such as Digital Frame or PDAs, support photo/picture display/edit functions. However, they are relatively expansive in price and limited in functions due to the LCD, and can't meet the demands of customers. Legacy Digital Media Players can only access CF Cards, SM Cards, or Micro Drive Cards from specific manufacturers, that is to say, legacy digital video/audio products can't support all flash memory cards, which results in low interoperability among them and brings inconvenience to customers.

### SUMMARY OF THE INVENTION

An object of the present invention is to provide a video/audio media player supporting various flash memory cards (including CF Card and MS/SD/MMC/SM Cards) so that it is possible for any of above flash memory cards to be accessible in the media player smoothly.

Another object of the present invention is to provide a media player supporting USB 1.1/2.0, IEEE 1394a/b, and IDE interfaces such that data can be exchanged directly with any flash memory inserted in it via above transmission interfaces, which significantly expands the application scope of this product. This invention combined the functions of legacy digital products and card readers, and meets the criterions for a new patent.

A further object of the present invention is to connect this product independently with existing IA products, such as HDTVs, Computers, Hi-Fi systems and etc., to play digital/analog video/audio signals. It needs not to be bundled with digital products with a LCE, such as Digital Frames or PDAs. As the result, the cost can be decreased and the market expands. It solves the problems in legacy media players, such as too few video/audio formats supported, too few types of flash memory cards supported, etc.

### BRIEF DESCRIPTION OF THE DRAWINGS

The detail structure, the applied principle, the function and the effectiveness of the present invention can be more fully understood by referring to the following description and accompanying drawings, in which:

FIG. 1 is a block chart of a typical legacy audio/video player product;

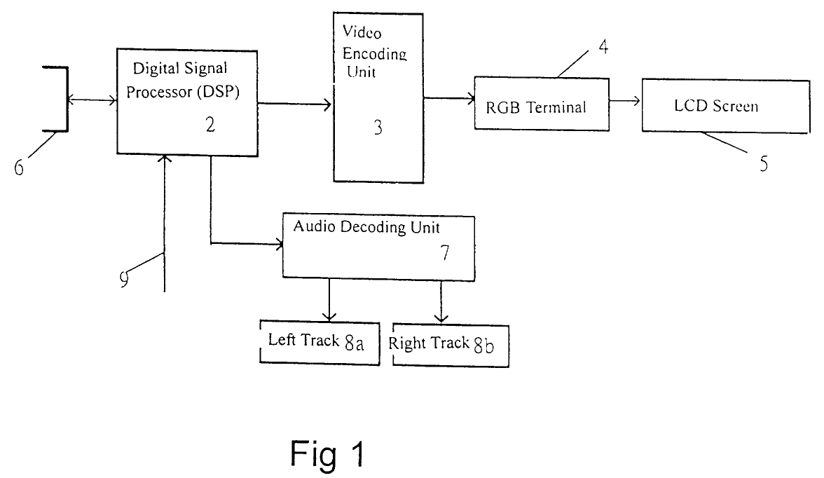

FIG. 2 is a block diagram of a preferred embodiment implemented according to this invention;

FIG. 3 is a flow chart of determination of the switching instructions of this invention;

FIG. 4 is a flow chart of the process when the media player receives an instruction; and

FIG. 5 is a flow chart for the actual operation of an embodiment of this invention.

### DETAILED DESCRIPTION OF THE PREFERRED EMBODIMENT

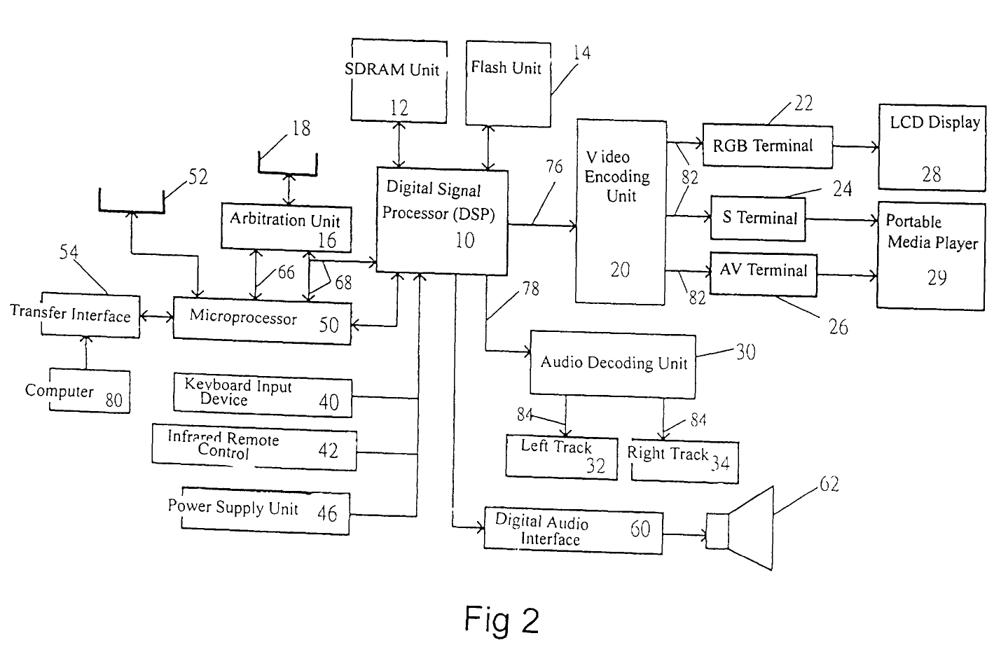

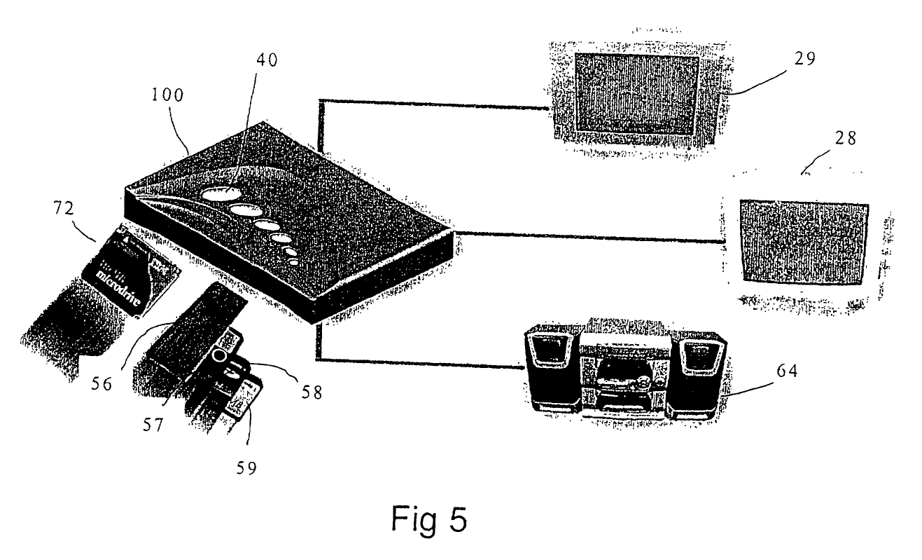

As shown in FIG. 2, the block diagram of a preferred embodiment of this invention, the “Video/Audio Media Player Supporting Various Flash Memory Cards” has a CF Card Socket (18) to host CF Cards (CF TYPE I, CF TYPE II/MicroDrive) (not shown, see FIG. 5), a combined socket (52) capable of identify and access various flash memory cards (MS/SD/MMC/SM Cards) (not shown, see FIG. 5). When a CF Card is inserted into the CF Card Socket (18) and an IDE interface is used at the system end (pre-specified, i.e., not USB or 1394 interface), the arbitration switch (16) will switch the IDE control signals (68) to the DSP (10) to process/decode the video/audio data and output digital videos (76)/audios (78). When the USB transfer interface (54) (depending on the interface of computer (80)) is connected, the arbitration switch will switch the USB/1394 control signals (66) to the microprocessor (50) to implement data exchange between the CF Card and the computer. When a SM/MS/MMC/SD Card is inserted in the combined socket (52) and a IDE Interface is used at the system end, the microprocessor (50) will control the DSP (10) to process/decode the digital video/audio data, and output digital video signals (76) and audio signals (78) to the Video Encoding Unit (20) and Audio Decoding Unit (30), respectively. When the transfer interface 54 is connected to a computer (80), the microprocessor (50) can control the exchange between flash memory cards described above and the computer (80).

The DSP (10) is equipped with a cache (SDRAM) (12) and a Flash Unit (14). The cache (SDRAM) (12) stores digital data for the DSP (10) to access. Thus improve the efficacy of DSP (10). The Flash Unit (14) stores the program, which controls the DSP (10).

The arbitration switch (16) between the CF Card and the DSP (10)/Microprocessor (50) is used to arbitrate and switch the instructions to the DSP (10) and the Microprocessor (50). It should be emphasized that this invention can be connected to a computer system (80) or independently used in LEDs (28), portable media players (29), or Hi-Fi systems. In brief, if the arbitration switch (16) detects a CF Card or other flash memory card using transfer interface 54, it can switch to USB/1394 Interface control signals (66), and warrant the microprocessor (5) to control the data exchange between flash memory cards and the computer (80). If this invention is used standalone, a CF Card can process/output digital video/audio signals through the DSP (10), while a SM/MS/MMC/SD Card outputs digital video/audio signals through the DSP (10) controlled by the microprocessor (50). In this way, once the transfer interface (54) is used, this invention serves as a general card reader/writer. The transfer interface integrates USB 1.1/2.0, IEEE 1394a/b, and IDE interfaces, supporting high data transferrate, hot-swapping, and plug-and-play (excluding IDE Interface).

This invention includes a Video Encoding Unit (20) and an Audio Decoding Unit (30) connected to the DSP (10). When the two units (20 and 30) accept and process video/audio data, they output an analog video signal (82) and an analog audio signal (84), respectively. The analog video signal from the Video Encoding Unit (20) may support RGB terminal (22), S terminal (24), and AV terminal (26). The RGB terminal can be connected to LEDs (28), the S terminal (24) and AV terminal (26) can be connected to a portable media player (29). The Audio Decoding Unit (30) further split the analog audio signal (84) into a left track (32) and a right track (34), or 6 tracks, i.e., for a Hi-Fi system.

The DSP (10) of this invention can be connected with a digital audio interface 960) to output audio signals to the amplifier (62) to improve the quality of audio. Besides serving as a Card Reader/Writer, this invention can also play video/audio and pictures independently powered by the Power Supply (46). The DSP (10) can be connected with a keyboard (40) or an infrared remote control (42) (not shown).

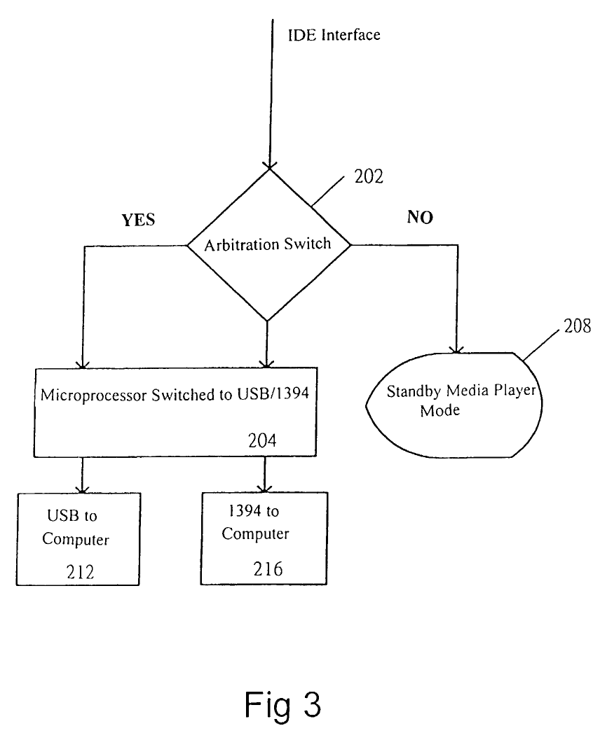

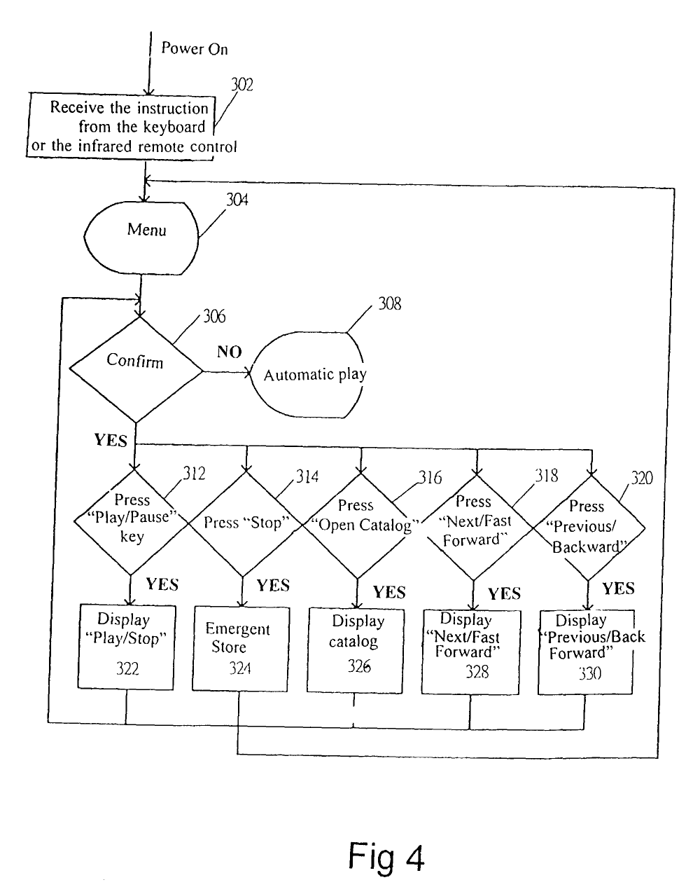

Referring to FIG. 3, a flow chart of the operation of the arbitration switch of this invention. Whether an IEEE 1394a/b or USB 1.1/2.0 Interface is used, the arbitration switch (202) will switch the instructions to the microprocessor and then to the USB/1394(204). The processed signals will be sent to the computers (212 and 216), and be displayed on the screens finally. If an IDE interface is used, the arbitration switch (202) will switch the system into the standalone mode (208). Please see FIG. 4, a flow chart of the media player of this invention. In the standalone mode, when this device receives a key press signal or a signal from the infrared remote control (302), a menu (304) will be displayed on the screen. If the signal (306) is not confirmed, the device will automatically execute the play process (308), and then return to the main menu. If the signal (206) is acknowledged, the device will receive at least 5 options, including Play/Pause (312), Stop (314), Open Catalog (316), Next Fast Forward (318), and Previous Fast Backward (320). When an option is selected and confirmed, the screen of computer will display Play/Pause (322), Stop (324), Open Catalog (326), Next Fast Forward (328), and Previous Fast Backward (330).

Referring to FIG. 5, a flow chart of the actual operation processor of an embodiment of this invention. From this figure we can see that the Digital Video/Audio Media Player (100) of this invention can access CF Cards (72), MS Cards (56), SM Cards 957), SD Cards (58) or MMC Cards (59) to encode/decode digital data and output digital/audio signals to HDTVs (29), computers 928), or Hi-Fi systems (64). The control of this device (100) can be done with the keyboard (40) or the infrared remote control (not shown in this figure).

It should be emphasized that this invention accesses various flash memory cards with the CF Socket and the Combined Socket. However, there is no restriction on the quantity of sockets, i.e., one or more sockets are allowed. In conclusion, the media player of this invention has the following advantages:

The “Video/Audio Media Player Supporting Various Flash Memory Cards” support various flash memory cards (including CF Card and MS/SD/MMC/SM Cards), i.e., digital data from various sources can be applied in this device. Another purpose of this invention is to provide a media player supporting USB 1.1/2.0, IEEE 1394a/b, and IDE interfaces. The media player of this invention can exchange data directly with any flash memory inserted in it via above transfer interfaces, which significantly expands the application scope of this product. This invention combined the functions of legacy digital products and card readers, and meets the criterions for a new patent.

Another purpose of this invention is to connect this product independently with existing IA products, such as HDTVs, Computers, or Hi-Fi Systems, etc., to play digital/analog video/audio signals. It needs not to be bundled with digital products with a LCE, such as Digital Frames or PDAs. As the result, the cost can be decreased and the market expands. It solves the problems in legacy media players, such as too few video/audio formats supported, too few types of flash memory cards supported, etc.

While the invention has been described with referencing to a preferred embodiment thereof, it is to be understood that modifications or variations may be easily made without departing from the spirit of this invention, which is defined by the appended claims.

1. A video/audio media player supporting various flash memory cards, comprising:
a CF Card Socket; receiving a CF Card;
a combined socket, identifying/accessing multi flash memory cards inserted;
a microprocessor, supporting the flash memory cards in the combined socket to identify the system interface (CF Interface or IDE Interface) so that if a CF interface is detected, the arbitration switch will switch to the microprocessor so as to control the data exchange between the CF Card and the CF transfer interface and if an IDE Interface is detected, the arbitration switch will switch to the DSP so as to serve as the controller;
a Video Encoding Unit, being connected to the DSP and receiving video signals to output analog video/audio signals; and
an audio decoding unit, being connected to the DSP and receiving audio signals to output analog audio signals.

2. The video/audio media player supporting various flash memory cards as defined in claim 1, wherein the DSP includes a cache (SDRAM) unit and a Flash unit and the cache (SDRAM) stores digital data for the DSP to access so as to improve the efficacy of DSP (10) such that the flash unit stores the program for controlling the DSP.

3. The video/audio media player supporting various flash memory cards as defined in claim 1, wherein the transfer interface integrates the USB 1.1/2.0, IEEE 1394a/b, and IDE interfaces, i.e., when any of above interface is used, the media player will identify it at once and switch to the corresponding processor to exchange data with the transfer interface; and on the contrary, when the transfer interface is not used, the media player will access the data in above flash memory cards via the DSP.

4. The video/audio media player supporting various flash memory cards as defined in claim 1, wherein the CF Card may be a CF TYPE I, CF TYPE 2, or Micro Drive cards.

5. The video/audio media player supporting various flash memory cards as claim 1, wherein the combined socket can host MS/SD/MMC/SM Cards.

6. The video/audio media player supporting various flash memory cards as defined in claim 1, wherein the analog video signal includes JPEG, MPEG 1, and MPEG2 formats of data.

7. The video/audio media player supporting various flash memory cards as defined in claim 1, wherein the analog audio signal include MP3 and CD formats.
